(19) United States
(12) Patent Application Publication
(10) Pub. No.: US 2026/0220414 A1
(43) Pub. Date: Jul. 30, 2026

(54) Contactless Module with Configurable Antenna Coil

(71) Applicant: SEALSQ FRANCE, Meyreuil (FR)

(72) Inventors: Ghislain Boiron, Aix en Provence (FR); Jean-Pierre Enguent, Aix en Provence (FR)

(21) Appl. No.: 18/722,549

(22) PCT Filed: Dec. 12, 2022
(86) PCT No.: PCT/FR2022/052315

§ 371 Date: Jun. 20, 2024

(30) Foreign Application Priority Data
Dec. 24, 2021 (FR) 2114518

(51) Int. Cl. G06K 19/07; G06K 19/077

(52) U.S. Cl. CPC G06K 19/0726; G06K 19/07747; G06K 19/07775; G06K 19/07783

(57) ABSTRACT

A contactless module that includes a microcircuit connected to an antenna coil having turns of which the rank increases from the outside to the inside of the antenna coil, including an external turn of rank 1 and an internal turn of rank N, the internal turn being connected to an internal connection pad and the external turn connected to an external connection pad, wherein the antenna coil comprises, in a bypass area, at least one connection pad for connecting to a turn of rank greater than 1, to which the microcircuit can be connected.

### TECHNICAL FIELD

The present invention relates to a contactless module and to a method for producing a contactless module of the type comprising an insert that comprises, on a first face, an antenna coil comprising turns of increasing rank from the outside to the inside of the antenna coil, including an external turn of rank 1 and an internal turn of rank N, the internal turn being connected to an internal connection pad and the external turn being connected to an external connection pad, a microcircuit attached to the first face of the insert, in a central area of the antenna coil bounded by a turn of the antenna coil, and comprising first connection terminals connected to connection pads of the antenna coil via wires. The external and internal connection pads of the antenna coil are formed in the central area of the antenna coil, the antenna coil comprising a bypass area in which each turn bypasses the external connection pad via the central area.

### PRIOR ART

A contactless module as defined above and a method for producing such a contactless module are described by WO 2014/006286 A1. One example of such a contactless module M1 is shown in FIG. 1. The contactless module M1 comprises an insert B1 which is covered on a first face, or rear face, with an electrically conductive layer in which an antenna coil A1 has been formed. The antenna coil A1 comprises N turns of increasing rank from the outside to the inside of the antenna coil, in this case eight turns L1 to L8, including an external turn L1 of rank 1 and an internal turn of rank N, in this case L8. The internal turn L8 is connected to an internal connection pad IP and the external turn L1 is connected to an external connection pad EP. A microcircuit MC is attached to the rear face of the insert B1 in a central area of the antenna coil A1 bounded by the contour of the internal turn L8, and comprises first connection terminals, or antenna connection terminals, connected to the connection pads EP, IP of the antenna coil via wires W1, W2. The external turn L1 follows the entire contour of the antenna coil A1 with the exception of an area that allows a conductive track T1 through which connects the external turn to the external connection pad EP. The connection pads EP, IP are formed in the central area of the antenna coil, the antenna coil comprising a bypass area BA1 in which each turn L1 to L8 bypasses the external connection pad EP via the central area.

In the context of producing a contactless module M1 with two, contact and contactless, communication modes, referred to as a “dual-interface” module, the insert B1 also comprises, on the other face, or front face, thereof, a second electrically conductive layer in which contact pads are formed, for example six contact pads of the ISO 7816 type (not shown). The insert B1 is then provided with holes h for routing wires CW that connect second connection terminals of the microcircuit MC, or contact-mode connection terminals, to all or some of these contact pads.

Wiring using the wires W1, W2, CW is generally carried out by ultrasonically welding the ends of the wires to the surfaces to be interconnected. This wiring technique, which is generally referred to as “ultrasonic wire bonding”, preferably requires the microcircuit to be mounted “flat”, i.e. parallel to the surface of the insert B1, so that the plane in which the connection terminals of the microcircuit lie is parallel to the plane in which the connection pads EP, IP of the antenna lie, and to the plane in which the contact pads lie on the other side of the module.

To this end, a support structure SS1 is provided in the center of the coil, in order to support the microcircuit across the width and part of the length thereof, the microcircuit also being supported across the width and another part of the length thereof by turns of the antenna coil in the bypass area BA1. The support structure SS1 comprises here a conductive path which forms part of the internal turn L8. Transverse conductive sections form, on either side thereof, two comb-shaped structures which allow the microcircuit to be supported across the entire width thereof.

After mounting the MC microcircuit on the module and wiring it thereto, the microcircuit is encapsulated in a layer of electrically insulating resin RL which extends over the central area of the antenna coil and covers the connection wires W1, W2 and CW, in order to afford it excellent mechanical strength.

Such an antenna structure provides a number of advantages, not least that it shortens the length of the wire W1 connecting the microcircuit to the external connection terminal EP of the antenna coil so that this connection wire is covered by the resin layer RL without this layer having to cover the entire module. Specifically, as explained in WO 2014/006286 A1, the module M1 is generally intended to be mounted in a cavity formed in a card, which comprises two depths. The first depth allows the cavity to accommodate the periphery of the module M1. The second depth is equal to the first depth plus the thickness of the resin layer RL, and allows the cavity to accommodate the portion of the module M1 that is covered by the resin layer RL. To avoid weakening the card, it is desirable for the area of the module covered by the resin layer RL to be minimal, so that the region of the cavity with the second depth is also minimal. This minimal area corresponds substantially to the central region of the coil in which the microcircuit MC and the wires W1, W2, CW are situated.

Another example of a conventional contactless module, M2, is shown in FIG. 2. The contactless module M2 comprises an antenna coil A2 and has the same general features as the module M1. It differs from the module M1 in that it comprises no support structure, with the bypass area, referred to here as BA2, occupying the center of the antenna coil A2. Thus, the microcircuit MC rests over the entire length and width thereof over portions of turns located in the bypass area. As before, this antenna coil structure allows the microcircuit MC to be mounted “flat” on the insert B1.

As shown in FIG. 3, such an antenna coil A1 or A2, once connected to the terminals of the microcircuit MC, forms, together with an internal capacitor IC of the microcircuit, an RLC resonant circuit that has to be tuned to a given resonant frequency, where:
“C” is the capacitance of an antenna capacitor inside the microcircuit MC,
“R” is the value of a series resistance Rm of the antenna coil, as seen by the microcircuit. This series resistance is represented in the figure by two resistors Rm1, Rm2 in series,
“L” is the value of an inductance Lm of the antenna coil, as seen by the microcircuit.

Configuring and optimizing a contactless module requires the antenna coil to be designed in such a way as to obtain a certain value for the RLC resonant circuit, and this value can depend on the card into which the module is to be inserted and on the intended application for that card. Designing the antenna coil to obtain the desired L and R values while taking into account the capacitance C of the microcircuit involves simulation tools which use various variables, including:
the number of turns and the length of the turns of the antenna coil, for an area of the module as dictated by the specifications,
the interturn distance and the width of the turns, the sum of these two values forming what is commonly known as the “pitch” of the antenna coil, and
the thickness of the conductive layer and therefore the thickness of the turns.

The resistance Rm is a resultant parameter that depends on the length, width and thickness of the turns that make up the antenna coil, and is equal to the product of the resistivity of the conductive layer into which the turns are etched and the length of the turns divided by their cross-sectional area. Constraining parameters are imposed by rules for the etching of the turns (“process constraints”) and for the minimum conduction of the turns (“electrical constraints”). In particular, the thickness of the turns must be greater than the skin thickness of the material of which they are made, e.g. 18 micrometers for turns made of copper and a working frequency of 13.56 MHz. Furthermore, the capacitance C of the antenna capacitor CI integrated into the microcircuit MC is liable to vary according to the microcircuit used and the intended application.

As a result, the conventional antenna coil structure described above does not allow the L and R values to be fine-tuned simply by varying the number of turns, for a predetermined pitch and turn thickness. It might therefore be desirable to refine such an antenna coil structure in a way as to allow the inductance thereof to be more finely tuned at the design stage.

In other cases, it might be desirable to provide an antenna coil structure that can be used with multiple types of microcircuits MC, the internal capacitance C of which is liable to vary substantially. Multiple antenna coil structures and multiple module types then have to be produced, which increases the production cost of a set of modules. It might therefore be desirable to provide a configurable antenna coil structure that can be used with different microcircuits, in order to reduce design and production costs.

### DISCLOSURE OF THE INVENTION

The present invention relates to a method for producing a contactless module, the method comprising the steps of depositing a first electrically conductive layer on a first face of an insert, forming an antenna coil by etching the first layer, the antenna coil comprising turns of increasing rank from the outside to the inside of the antenna coil, including an external turn of rank 1 and an internal turn of rank N, the internal turn being connected to an internal connection pad and the external turn being connected to an external connection pad, attaching a microcircuit to the first face of the insert, in a central area of the antenna coil bounded by a turn of the antenna coil, connecting first connection terminals of the microcircuit to connection pads of the antenna coil, via wires, in which method the external and internal connection pads of the antenna coil are formed in the central area of the antenna coil, the antenna coil comprising a bypass area in which each turn bypasses the external connection pad via the central area, and wherein the conductive layer is etched in such a way that the antenna coil comprises, in the bypass area, at least one connection pad for connecting to a turn of rank greater than 1 to which at least one of the first connection terminals of the microcircuit is connected or can be connected.

According to one embodiment, the conductive layer is etched in such a way that the antenna coil has the following characteristics: the antenna coil comprises a first group of turns of ranks 1 to E, the turns of the first group having substantially the same interturn distance, the turn of rank E being the internal turn of the first group of turns, E being at least equal to 4, the central area is bounded by the contour of the internal turn of rank E of the first group of turns, and the antenna coil comprises a second group of at least two turns of ranks E+1 to N, which extends into the central area, each turn of the second group of turns comprising turn portions which are situated at variable distances from the turn of preceding rank, said distances being between said interturn distance and multiple times the interturn distance.

According to one embodiment, the conductive layer is etched in such a way that the antenna coil comprises at least one connection pad for connecting to a turn of rank lower than N of the second group of turns.

According to one embodiment, the microcircuit is fully or partly supported by at least the internal turn of the antenna coil and can also be supported by at least one turn portion of the first group of turns extending into the bypass area.

According to one embodiment, the method comprises steps of depositing a second electrically conductive layer on a second face of the insert, forming contact pads in the second layer, forming two rows of two or three holes each in the insert until the contact pads of the second layer are reached, the rows of holes being substantially perpendicular to a longitudinal axis of the module, and connecting second connection terminals of the microcircuit to the contact pads of the second layer via wires that pass through the holes, wherein all or some of the turns of the second group of turns follow a path that passes between at least two holes of at least one row of holes.

According to one embodiment, the conductive layer is etched so as to comprise a support structure for supporting all or part of the microcircuit, the support structure being electrically connected to a turn of the antenna coil.

According to one embodiment, at least a portion of the support structure forms a conductive path which forms part of the internal turn of the antenna coil.

According to one embodiment, the method comprises a step of depositing an electrically insulating protective layer on the microcircuit and the connection wires.

According to one embodiment, the method comprises a step of designing the antenna coil which comprises a step of determining a plurality of target values for the inductance and target values for the resistance of the antenna coil as should be seen from the first connection terminals of the microcircuit, a step of designing the turns of the antenna coil, the step comprising the provision of multiple connection pads for connecting to turns of different ranks, such that the antenna coil has multiple pairs of connection pads, each pair of connection pads comprising a connection pad for connecting to a turn of the first group of turns and a connection pad for connecting to a turn of the second group of turns, and wherein the choice of the location of the connection terminals is made in such a way that the inductance and the resistance of the antenna coil as seen from each pair of connection pads of the antenna coil are close to one of the values of the plurality of target values for the inductance and target values for the resistance of the antenna coil.

The invention also relates to a method for producing a microcircuit card, the method comprising the steps of carrying out the method described hereinabove to obtain a contactless module, forming an antenna coil in a card, and implanting the module into the card, the antenna coil of the card having at least one turn close to the antenna coil of the microcircuit in order to establish an inductive coupling between the two antenna coils.

The invention also relates to a contactless module comprising an insert that comprises, on a first face, an antenna coil comprising turns of increasing rank from the outside to the inside of the antenna coil, including an external turn of rank 1 and an internal turn of rank N, the internal turn being connected to an internal connection pad and the external turn being connected to an external connection pad, a microcircuit attached to the first face of the insert, in a central area of the antenna coil bounded by a turn of the antenna coil, and comprising first connection terminals connected to connection pads of the antenna coil via wires, wherein the external and internal connection pads of the antenna coil are formed in the central area of the antenna coil, the antenna coil comprising a bypass area in which each turn bypasses the external connection pad via the central area, and wherein the antenna coil comprises, in the bypass area, at least one connection pad for connecting to a turn of rank greater than 1 to which at least one of the first connection terminals of the microcircuit is connected or can be connected.

According to one embodiment, the antenna coil comprises a first group of turns of ranks 1 to E, the turns of the first group having substantially the same interturn distance, the turn of rank E being the internal turn of the first group of turns, E being at least equal to 4, the central area is bounded by the contour of the internal turn of rank E of the first group of turns, and the antenna coil comprises a second group of at least two turns of ranks E+1 to N, which extends into the central area, each turn of the second group of turns comprising turn portions which are situated at variable distances from the turn of preceding rank, said distances being between said interturn distance and multiple times the interturn distance.

According to one embodiment, the antenna coil comprises at least one connection pad for connecting to a turn of rank lower than N of the second group of turns.

According to one embodiment, the microcircuit is fully or partly supported by at least the internal turn of the antenna coil and can also be supported by at least one turn portion of the first group of turns extending into the bypass area.

According to one embodiment, the module comprises contact pads on a second face of the insert, two rows of two or three holes each which pass through the insert until the contact pads on the second face of the insert are reached, the rows of holes being substantially perpendicular to a longitudinal axis of the module, wires that pass through holes connecting second connection terminals of the microcircuit to the contact pads of the second face of the insert, and wherein all or some of the turns of the second group of turns follow a path that passes between at least two holes of at least one row of holes.

According to one embodiment, the module comprises a support structure for supporting all or part of the microcircuit, the support structure being electrically connected to a turn of the antenna coil.

According to one embodiment, at least a portion of the support structure forms a conductive path which forms part of the internal turn of the antenna coil.

According to one embodiment, the module comprises an electrically insulating protective layer on the microcircuit and the connection wires.

The invention also relates to a microcircuit card comprising an antenna coil and a module as described hereinabove, the antenna coil of the card having at least one turn close to the antenna coil of the module in order to establish an inductive coupling between the two antenna coils.

### BRIEF DESCRIPTION OF FIGURES

Exemplary embodiments of contactless modules and of methods for producing such contactless modules will be described hereinafter by way of non-limiting example, with reference to the attached figures in which:

FIG. 1, described hereinabove, shows a conventional contactless module,

FIG. 2, described hereinabove, shows another conventional contactless module,

FIG. 3 is a circuit diagram of an antenna circuit of the contactless module of FIG. 1 or FIG. 2,

FIG. 4A shows the rear face of a first embodiment of a contactless module insert,

FIG. 4B shows the rear face of a contactless module formed on the basis of the insert of FIG. 4A,

FIG. 5 shows the front face of the insert of FIG. 4A,

FIG. 6 is a circuit diagram of an antenna circuit of the contactless module of FIG. 4B,

FIG. 7A shows the rear face of a variant of the insert of FIG. 4A,

FIG. 7B shows the rear face of a contactless module formed on the basis of the insert of FIG. 7A,

FIG. 8A shows the rear face of another variant of the insert of FIG. 4A,

FIG. 8B shows the rear face of a contactless module formed on the basis of the insert of FIG. 8A,

FIG. 9A shows the rear face of yet another variant of the insert of FIG. 4A,

FIG. 9B shows the rear face of a contactless module formed on the basis of the insert of FIG. 9A,

FIG. 10 shows the rear face of yet another variant of the insert of FIG. 4A,

FIGS. 11A and 11B are identical and show the rear face of a second embodiment of a contactless module insert,

FIG. 11C shows the rear face of a contactless module formed on the basis of the insert of FIG. 11A,

FIG. 11D shows the rear face of another contactless module formed on the basis of the insert of FIG. 11A,

FIG. 12 shows the front face of the insert of FIG. 11A,

FIG. 13 is a circuit diagram of an antenna circuit of the contactless module of FIG. 11C or of FIG. 11D,

FIG. 14 shows the rear face of a variant of the insert of FIG. 11A,

FIG. 15 shows the rear face of another variant of the insert of FIG. 11A,

FIG. 16 shows the rear face of yet another variant of the insert of FIG. 11A,

FIG. 17 shows the rear face of yet another variant of the insert of FIG. 11A,

FIG. 18 shows the rear face of yet another variant of the insert of FIG. 11A,

FIGS. 19A and 19B show a step in a method for producing a contactless module insert,

FIG. 20 shows a card fitted with a contactless module,

FIG. 21 is a cross-sectional view of the chip card of FIG. 20.

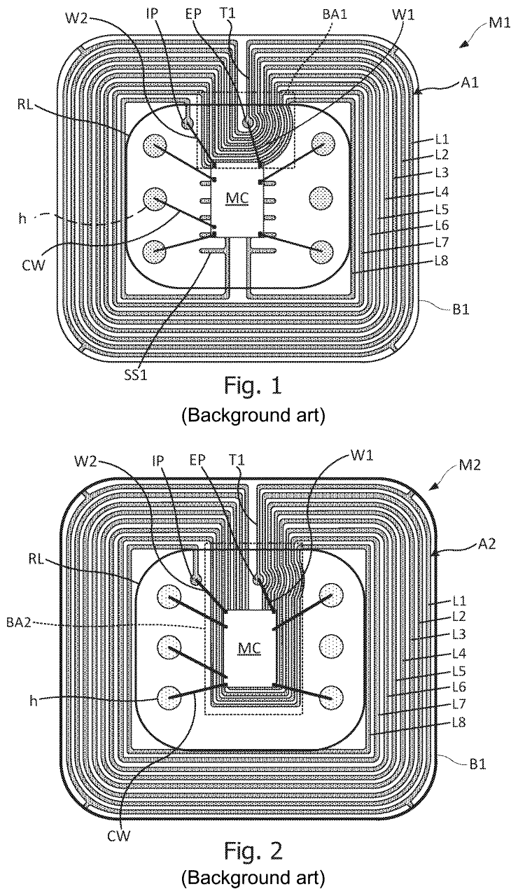

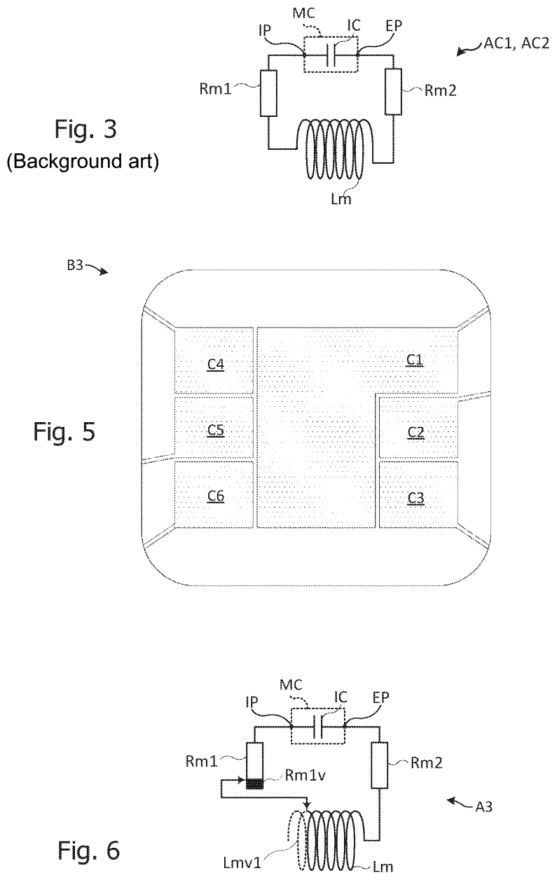

### DETAILED DESCRIPTION

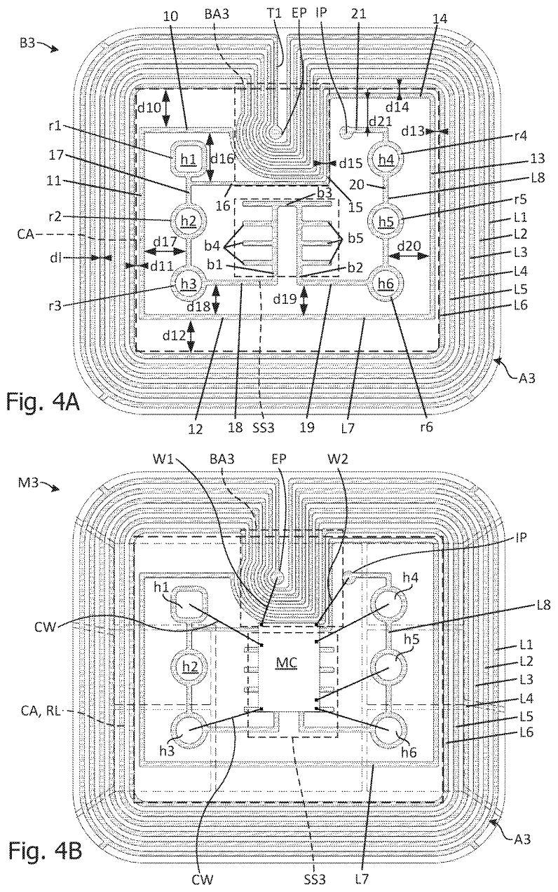

FIG. 4A shows the rear face of a contactless module insert B3, and FIG. 5 shows the front face of the insert B3. The insert is made of an electrically insulating material, such as epoxy, and has a front face and rear face. Each face is covered with a conductive layer, hereinafter referred to as the “front conductive layer” and the “rear conductive layer”. The rear conductive layer has been etched to form an antenna coil A3 (FIG. 4A) and the front conductive layer has been etched to form contact pads C1-C6 (FIG. 5). The thickness of the insert B3 is, for example, about a hundred micrometers, and its dimensions are, for example, about 13 mm×11.8 mm. The two conductive layers are made of copper, for example. In some embodiments, the copper can be covered with a finishing layer of nickel, gold, palladium or a stack of these materials. Nickel is generally used to prevent the oxidation of the copper. Gold is generally used to improve the electrical conductivity of the conductive layers. Palladium can be used to improve the visual appearance of the conductive layer on the front face (silvery appearance). The copper/nickel/gold combination is the one most commonly used in industry, and the copper/nickel/gold/palladium combination is more rarely used. In general, insert B3, as well as all of the inserts described hereinafter, can be produced using any current or future technology for depositing a conductive layer on a rigid or flexible support, and etching the conductive layer. A method for batch-producing a plurality of inserts will be described hereinafter.

Contact pads C1 to C6 (FIG. 5) on the front face are, for example, contact pads that are in accordance with standard ISO 7816, and comprise five active contact pads (Vcc, Clock, GND, RST, I/O) and one contact pad reserved for future use (RFU) or specific to certain applications. The insert M also comprises holes h1 to h6 made from the rear face and leading to the rear face of contact pads C1 to C6 on the front face, without passing through these pads. These holes can be formed before or after deposition of the conductive layers. They form two rows h1, h2, h3, and h4, h5, h6, respectively, of three holes each. Depending on the production method used, the rear face of insert B3 can comprise conductive collars, or conductive rings r1 to r6, which extend around holes h1 to h6 and are formed during the step of etching the rear conductive layer to form antenna coil A3.

Antenna coil A3 (FIG. 4A) has a structure in accordance with a first refinement and will now be described in detail. Antenna coil A3 comprises N turns of increasing rank from the outside to the inside of the antenna coil, in this case 8 turns L1 to L8, i.e. N=8. Turn L1 of rank 1 is the external turn and turn L8 of rank 8 is the internal turn of the antenna coil. The internal turn L8 is connected to an internal connection pad IP and the external turn L1 is connected to an external connection pad EP. In accordance with the teaching of WO 2014/006286 A1, the connection pads EP, IP are formed in a central area CA of the antenna coil, the antenna coil comprising a bypass area BA3 in which each turn L1 to L8 bypasses the external connection pad EP via the central area CA. The external turn L1 follows the entire contour of the antenna coil with the exception of an area that allows a conductive track T1 through which connects the external connection pad EP to the external turn L1. In such an antenna coil structure A3, a distinction is thus made between the “contour” of the antenna coil, which is defined by the general shape of the external turn L1 without taking into account the bypass area BA3, and the “outside” of the external turn L1, which includes the track T1 connecting the external turn L1 to the external connection pad EP. The bypass area BA3 and the central area CA are shown in dashed lines in FIG. 4A. The bypass area BA3 extends into the central area CA, which includes the connection terminals EP, IP of the antenna coil.

Optionally, insert B3 also comprises a support structure SS3 in order to ensure flatness when mounting a microcircuit on the insert. Support structure SS3 is substantially “π”-shaped in this case and comprises a first branch b1 and a second branch b2 which are parallel to one another, and a third, transverse branch b3 connecting branches b1, b2. It also comprises three branches b4 which are parallel to branch b3 and connected to branch b1, and three branches b5 which are parallel to branch b3 and connected to branch b2. Branches b1, b2 and the portion of branch b3 which connects branches b1, b2 here form an integral part of the conductive path forming the internal turn L8.

According to the first refinement, the antenna coil:
comprises a first group of turns of ranks 1 to E, in this case turns L1 to L6, i.e. E=6, having substantially the same interturn distance dl, the turn of rank E, in this case turn L6, being the internal turn of the first group of turns,
the central area CA of the antenna coil is bounded by the contour of the internal turn of rank E of the first group of turns, in this case turn L6. What is meant by “bounded by the contour of the internal turn of rank E” is that the central area is bounded by the overall shape of the turn of rank E, ignoring the bypass area, which extends into the central area and therefore comprises portions of turns of the first group of turns belonging to the bypass area.
the antenna coil comprises a second group of at least two turns with ranks from E+1 to N, E+1 in this case being equal to 7, which extend into the central area CA. The second group of turns in this case comprises turns L7 and L8.
each turn of the second group of turns, in this case L7 and L8, comprises turn portions that are at variable distances from the turn of preceding rank, in this case turn L6 for turn L7 and turn L7 for turn L8. These distances are between the interturn distance and multiple times the interturn distance dl of the first group of turns.

In this example, turn L7 comprises turn portions 10 to 14. Portion 10 comprises a curved section of conductive track belonging to the bypass area BA3 followed by a straight section of track leading away from the bypass area and at a distance d10 from turn L6. Portion 11 is a straight section of track perpendicular to section 10 and at a distance d11 from turn L6. Portion 12 is a straight section of track perpendicular to section 11 and at a distance d12 from turn L6. Portion 13 is a straight section of track perpendicular to section 12 and at a distance d13 from turn L6. Portion 14 is a straight section of track perpendicular to section 13 and at a distance d14 from turn L6. Portion 15 is a straight section of track perpendicular to section 14 and at a distance d15 from turn L6. Distances d11, d13, d14 and d15 are equal to the interturn distance dl of the first group of turns. Distances d10 and d12 are multiple times greater than distance dl.

Turn L8 comprises portions 16 to 21. Portion 16 is a straight section of track leading away from the bypass area, until it is at a distance d16 from portion 10 of turn L7. Portion 17 comprises a straight section of track at a distance d17 from portion 11 of turn L7, and two conductive rings r2 and r3 surrounding holes h2 and h3. Portion 18 is a straight section of track at a distance d18 from portion 12 of turn L7 and attached to branch b1 of support structure SS3. Portion 19 is a straight section of track at a distance d19 equal to d18 from portion 12 of turn L7 and attached to branch b2 of support structure SS3. Portion 20 comprises three straight sections of track at a distance d20 from portion 13 of turn L7, and three conductive rings r4, r5, r6 extending around holes h4, h5, h6. Portion 21 is a straight section of track at a distance d21 from portion 14 of turn L7, terminating at the internal connection terminal IP of the antenna coil. Distances d16, d17, d18, d19, d20 and d21 are each multiple times greater than the interturn distance dl. The edge of hole h1 also comprises a conductive ring r1 that is attached to portion 16 but does not form part of the conductive path of turn L8. As mentioned hereinabove, branches b1, b2 and the portion of branch b3 that connects branches b1, b2 of support structure SS3 here form an integral part of turn L8.

FIG. 4B shows a contactless module M3 produced on the basis of insert B3. A microcircuit MC has been attached to the insert using an electrically insulating adhesive. First connection terminals of the microcircuit, or antenna connection terminals, have been connected by wires W1, W2 to the connection pads EP, IP of antenna coil A3. Second connection terminals of the microcircuit, or contact-mode connection terminals, have been connected to contact pads C1, C3 to C6 on the front face (FIG. 5) by wires CW that pass through holes h1, h3 to h6, which reach the rear face of these contacts without passing through them. The microcircuit MC rests over part of the length and the entire width thereof on support structure SS3 and over another part of the length and the entire width thereof on portions of turns in the bypass area, in this case a portion of turn L7 and portion 1 of turn L8. The central area CA of the antenna coil A3, which is bounded in this case by the contour of turn L6, has been coated with a resin layer RL to mechanically protect the wires. In practice, and depending on the tolerances of the encapsulation process, this resin layer might not coincide exactly with the central area CA, and might comprise a safety margin that extends over one or more turns of the first group of turns.

According to the present refinement, the turns of the second group of turns, in this case L7, L8, have a complex shape that can be varied as the designer sees fit, offering additional leeway in the design of the antenna coil in order to fine-tune the inductance thereof to a desired value, while adjusting the value of its series resistance. As shown in FIG. 6, once connected to the microcircuit, the antenna coil A3 forms, with an internal capacitor IC of the microcircuit MC, an RLC resonant circuit that can be tuned to a given resonant frequency, where:
“C” is the capacitance of an internal capacitor of the microcircuit MC (antenna capacitor),
“R” is the value of a series resistance Rm of the antenna coil, as seen by the microcircuit, represented by two resistors Rm1, Rm2 in series,
“L” is the value of an inductance Lm of the antenna coil, as seen by the microcircuit.

Lmv1 is the part of the inductance of the antenna coil that can be varied according to the shape given to turns L7 and L8, and Rm1v is the part of the resistance of the antenna coil that can be varied according to the shape given to turns L7 and L8. The design of turns L7 and L8, and in general of the turns in the second group, therefore affords an additional degree of freedom to obtain a desired value for the RLC resonant circuit, in addition to conventional design variables such as the number of turns and the length of the turns of the first group of turns, the interturn distance and the width of the turns, the thickness of the conductive layer and therefore the thickness of the turns, etc.

FIG. 4B shows a contactless module M3 produced on the basis of insert B3. A microcircuit MC has been attached to the insert. The first connection terminals of the microcircuit have been connected by wires W1, W2 to the connection pads EP, IP of the antenna coil A3. The second terminals of the microcircuit have been connected by wires CW that pass through holes h1, h3 to h6 to contact pads C1, C3 to C6 on the front face (FIG. 5). The microcircuit rests over part of the length and the entire width thereof on support structure SS3 and over another part of the length and the entire width thereof on portions of turns in the bypass area, in this case part of portion 10 of turn L7 and part of portion 16 of turn L8. The central area CA of the antenna coil A3, which is bounded in this case by the contour of turn L6, is coated with a resin layer RL to mechanically protect the wires. As mentioned hereinabove, this resin layer might not coincide exactly with the center area CA, and might comprise a safety margin.

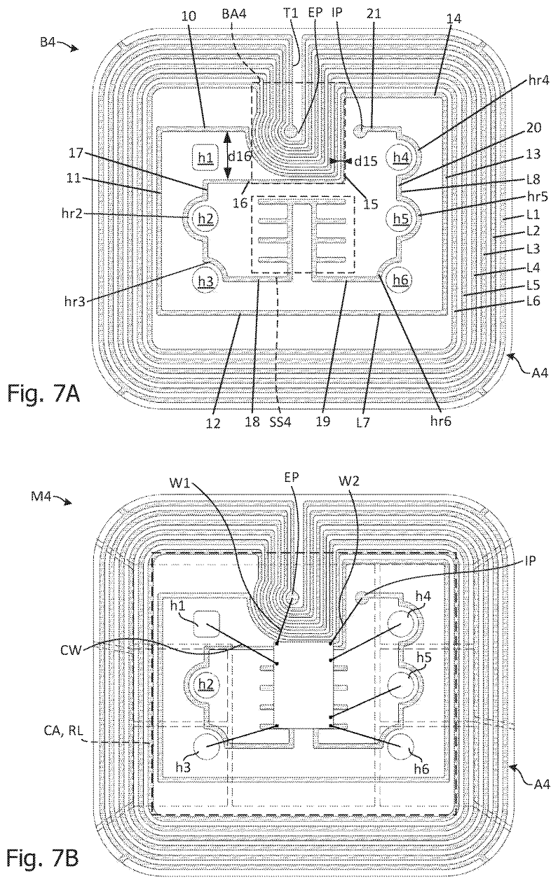

FIG. 7A shows a variant B4 of insert B3 which comprises an antenna coil A4 of the same general structure as the antenna coil A3, with a support structure SS4 that is identical to support structure SS3 and a bypass area BA4 that is identical to bypass area BA3. The antenna coil A4 differs from the antenna coil A3 in that the peripheries of holes h1 to h6 are without conductive rings. In this case, portion 17 of turn L8 comprises, instead of the conductive rings, a semicircular section of track hr2 which bypasses hole h2, and a quarter-circular section of track hr3 which bypasses hole h3. Similarly, portion 20 of turn L8 comprises a quarter-circular section of conductive track hr6 which bypasses hole h6, a semicircular section of track hr5 which bypasses hole h5, and a semicircular section of track hr4 which bypasses hole h4.

A contactless module M4 produced on the basis of insert B4 is shown in FIG. 7B. Contactless module M4 is identical to contactless module M3 except for the differences just mentioned, and the above description of contactless module M3 applies to contactless module M4.

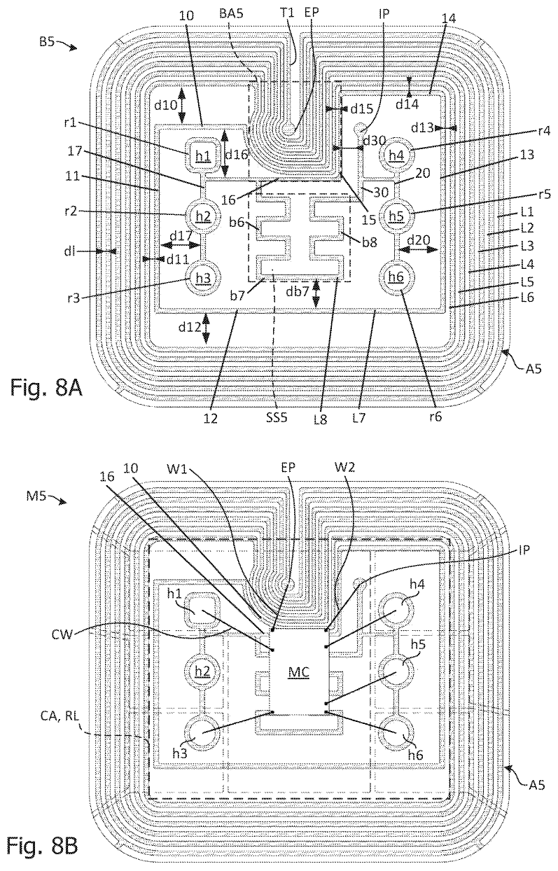

FIG. 8A shows a variant B5 of insert B3 which comprises an antenna coil A5 in which the first group of turns comprises turns L1 to L6 and the second group of turns comprises turns L7 and L8. Turns L1 to L6 of the first group, and turn L7 of the second group, are identical to turns L1 to L7 of antenna coil A3 on insert B3, and bypass area BA5 is identical to bypass area BA3.

Insert B5 comprises here a support structure SS5 comprising branches b6, b7, b8, branches b6 and b8 being crenellation-shaped and branch b7 connecting branches b6 and b8.

Turn L7 comprises turn portions 10 to 15 which have already been described. Turn L8 comprises portion 16 which has already been described, branches b6, b7, b8 of support structure SS5 and a turn portion 30. Portion 16 is attached to a termination of branch b6, and portion 30 is a straight section of track attached to a termination of branch b8, which terminates at the internal connection pad IP of the antenna coil.

Insert B5 also comprises portion 17 and conductive rings r1, r2, r3 described hereinabove, which are connected to portion 16 but no longer form part of the conductive path of turn L8. Similarly, portion 20 and conductive rings r4, r5, r6 described hereinabove are connected to portion 30 but no longer form part of the conductive path of turn L8.

FIG. 8B shows a contactless module M5 produced on the basis of insert B5. As before, the first connection terminals of a microcircuit MC have been connected by wires W1, W2 to the connection pads EP, IP of antenna coil A5, and the second connection terminals of the microcircuit have been connected by wires that pass through holes h1, h3 to h6 to contact pads C1, C3 to C6 on the front face (FIG. 5). The microcircuit rests over part of the length and the entire width thereof on support structure SS5 and over another part of the length and the entire width thereof on part of portion 16 of turn L8 and part of portion 10 of turn L7. The central area CA of the antenna coil A5, which is bounded in this case by the contour of turn L6, was coated with a resin layer RL to mechanically protect the wires.

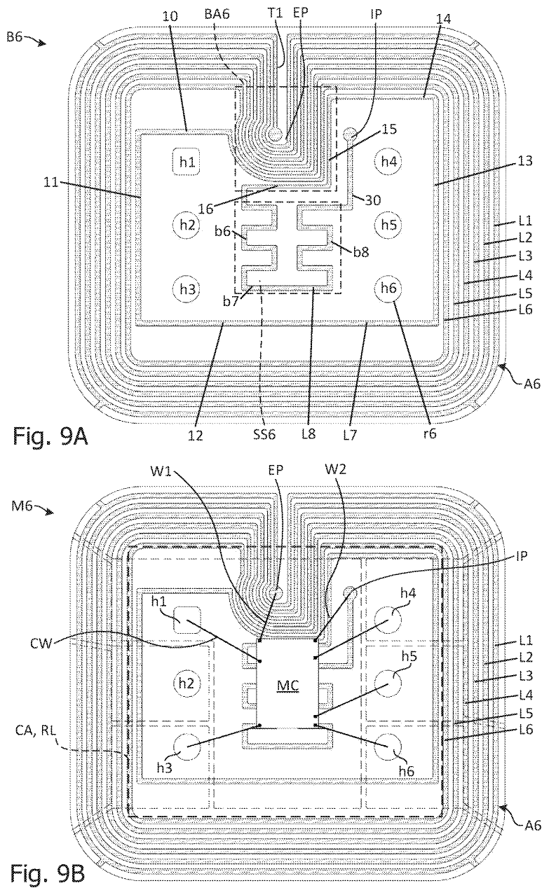

FIG. 9A shows a variant B6 of insert B5 which comprises an antenna coil A6 of the same general structure as antenna coil A5, with a support structure SS6 that is identical to support structure SS5 and a bypass area BA6 that is identical to bypass area BA5. Insert B6 differs from insert B5 in that the peripheries of holes h1 to h6 are without conductive rings. In this case, portion 17 and conductive rings r1, r2, r3, and portion 20 and conductive rings r4, r5, r6, which have been described hereinabove as not forming part of the conductive path of turn L8, have been removed.

A contactless module M6 produced on the basis of insert B6 is shown in FIG. 9B. Contactless module M6 is identical to contactless module M5 except for the differences just mentioned, and the above description of contactless module M5 applies to contactless module M6.

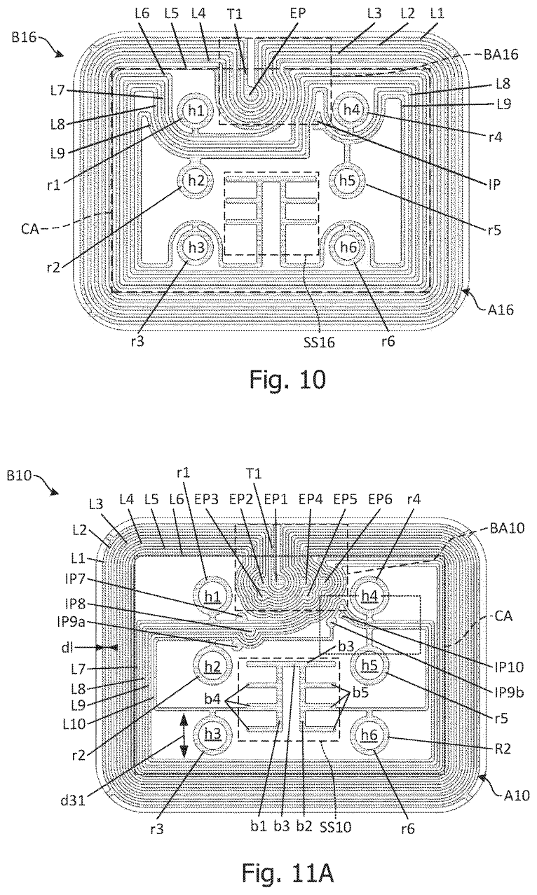

An antenna coil according to the first refinement is subject to various variants other than those described above. By way of illustration, FIG. 10 shows an exemplary application of the first refinement to an insert B16 that has dimensions of about 11 mm×8.32 mm. insert B16 comprises an antenna coil A16 comprising a first group of turns L1 to L5 spaced apart by the interturn distance dl described hereinabove, a second group of turns comprising turns L6 to L9 which have variable distances relative to the turns of preceding ranks, and a substantially “π”-shaped support structure SS16 of the type described above. Insert B16 also comprises conductive rings r1 to r6 extending around holes h1 to h6, with holes h1 to h6 forming a first row of holes h1 to h3 and a second row of holes h4 to h6, each row being perpendicular to a longitudinal axis of the module. In some embodiments, the holes might not be perfectly aligned. Their axis of alignment can then be defined as an axis that passes as close as possible to the center of each hole. This axis might not be perfectly perpendicular to the longitudinal axis of the module, so “perpendicular” is understood to mean “substantially perpendicular”. In the case of a module of substantially square shape, the longitudinal axis of the module will be defined as an axis perpendicular to a longitudinal axis of the microcircuit MC, the rows of holes therefore being parallel to the longitudinal axis of the microcircuit, or substantially parallel to this axis.

According to one optional but advantageous aspect of the first refinement, applicable in particular to a module comprising the holes described hereinabove, turns L6, L7, L8 lead away from turn L5 after bypass area BA16 in order to pass between holes h1 and h2 and the conductive rings r1, r2 thereof, and then return to the vicinity of turn L6 with an interturn distance equal to dl. Turn L9 then leads away from turn L8 in order to bypass hole h3 and the conductive ring r3 thereof, before extending into support structure SS16. On leaving support structure SS16, turn L9 bypasses hole h6 and the conductive ring r6 thereof, and then passes between holes h4, h5 and the conductive rings thereof in order to reach the connection pad IP. Turn L8 also follows a path that passes between holes h4, h5 and the conductive rings thereof.

Conductive rings r1, r3, r5, r6 are connected to turn L9, and conductive ring r4 is connected to turn L8, but they do not form part of the conductive paths of these turns. The central area CA is bounded by the contour of turn L6, and the external connection pad EP is located in the central area as before.

In practice, the first group of turns generally comprises at least four turns, in order to cover the needs of known applications under technological conditions of use corresponding to the current state of the art, but the first refinement is not necessarily limited to this minimum number of turns of the first group.

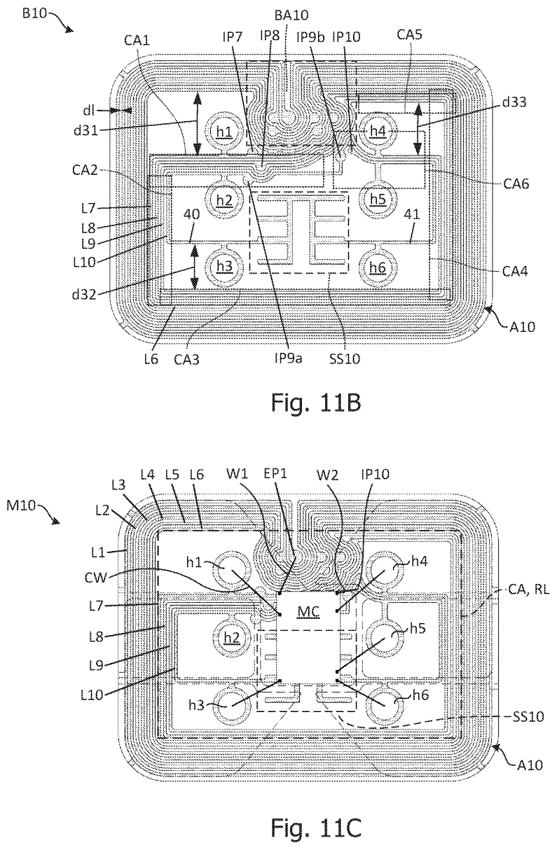

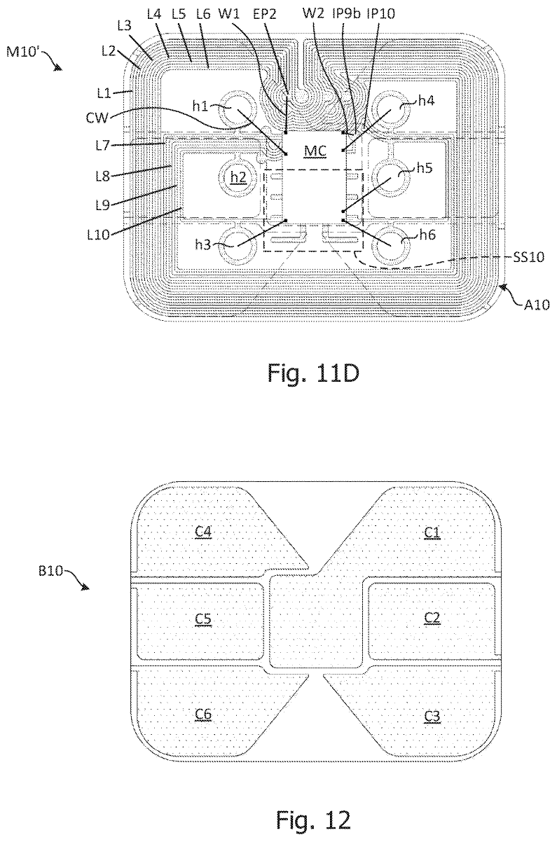

FIGS. 11A and 11B show the rear face of an insert B10 implementing the first refinement and a second refinement. The two figures are identical, but FIG. 11B shows references for elements that are not shown in FIG. 11A for the sake of legibility of FIG. 11A. FIG. 12 shows the front face of insert B10. This comprises six contact pads C1 to C6, for example ISO 7816 contact pads. Its dimensions are, for example, 11 mm×8.32 mm.

With reference to FIGS. 11A and 11B, the rear face of insert B10 comprises 10 turns (N=10) divided into a first group of six turns L1 to L6 (E=6) and a second group of four turns L7 to L10. The turns of the first group of turns L1 to L6 have substantially the same interturn distance dl, the contour of turn L6 bounding a central area CA within which are formed an external connection pad EP1 of the antenna coil and an internal connection pad IP10 of the antenna coil. The external connection pad allows connection to turn L1 and the internal connection pad IP10 allows connection to turn L10. As before, coil A10 comprises a bypass area BA10 in which each turn L1 to L10 bypasses the external connection pad EP1 via the central area CA. The external turn L1 follows the entire contour of the antenna coil with the exception of an area that allows through a conductive track T1 outside the external turn L1 and connecting the external turn L1 to the connection pad EP1.

Insert B10 also comprises holes h1 to h6 made from the rear face thereof and leading to the rear face of contact pads C1 to C6 on the front face, without passing through these pads, and conductive rings r1 to r6 extending around holes h1 to h6. The holes form a first row of holes h1 to h3 and a second row of holes h4 to h6 perpendicular or substantially perpendicular to a longitudinal axis of the insert. As before, in some embodiments the holes might not be perfectly aligned, in which case the axis of alignment thereof is defined as an axis that passes as close as possible to the center of each hole.

Insert B10 also comprises a support structure SS10, which is substantially “π”-shaped in this case, comprising a first branch b1 and a second branch b2 which are parallel to one another, a third, transverse branch b3 connecting branches b1, b2, three branches b4 which are parallel to branch b3 and attached to branch b1, and three branches b5 which are parallel to branch b3 and attached to branch b2.

The turns of the second group of turns L7-L10 comprise turn portions that are at a greater distance from the turn of preceding rank than the interturn distance dl of the first group of turns L1-L6. In particular, as shown in FIG. 11B, turns L7-L10 comprise a first group CA1 of turn portions that are spaced apart from one another by the interturn distance dl, the portion of turn L7 of group CA1 being spaced apart from turn L6 by a distance d31 which is multiple times greater than the distance dl. After group CA1, turns L7-L10 comprise a group CA2 of turn portions that are perpendicular to the turn portions of group CA1 and are spaced apart from one another by the interturn distance dl, the portion of turn L7 of group CA2 being spaced apart from turn L6 by the distance dl. After group CA2, turns L7-L9 comprise a group CA3 of turn portions that are perpendicular to the turn portions of group CA2 and are spaced apart from one another by the interturn distance dl, the portion of turn L7 of group CA3 being spaced apart from turn L6 by the distance dl. Turn L10 then comprises a turn portion 40 perpendicular to the turn portions of group CA2, which connects the portion of turn L10 of group CA2 to a branch b4 of support structure SS10 (FIGS. 11A and 11B together). After group CA3, turns L7-L10 comprise a group CA4 of turn portions that are perpendicular to the turn portions of group CA3 and are spaced apart from one another by the interturn distance dl.

The portion of turn L7 of group CA4 is spaced apart from turn L6 by the distance dl. Portion 40 of turn L10 is spaced apart from the portion of turn L9 of group CA3 by a distance d32 which is multiple times greater than the distance dl. Turn L10 also comprises a turn portion 41 perpendicular to the turn portions of group CA4, which connects the portion of turn L10 of group CA4 to a branch b5 of support structure SS10. Portion 41 of turn L10 is at a distance d32 from the portion of turn L9 of group CA3 (FIGS. 11A and 11B together). After group CA4, turns L7-L8 comprise a group CA5 of turn portions that are perpendicular to the turn portions of group CA4 and are spaced apart from one another by the interturn distance dl, the portion of turn L7 of group CA5 being spaced apart from turn L6 by the distance dl. The portions of turns L7-L8 of group CA5 join the bypass area BA10. Still after group CA4, turns L9-L10 comprise a group CA6 of turn portions that are perpendicular to the turn portions of group CA4 and are spaced apart from one another by the interturn distance dl, the portion of turn L9 of group CA6 being spaced apart from the portion of turn L8 of group CA5 by a distance d33 times greater than the distance dl. The portion of turn L10 of group CA6 ends in the connection terminal IP10.

After the bypass area, the turn portions of group CA1 of turns L7 to L10 follow a path that passes between holes h1 and h2 and the conductive rings r1, r2 thereof. The turn portions of group CA6 of turns L9 and L10 follow a path that passes between holes h4 and h5 and the conductive rings r4, r5 thereof.

Part of support structure SS10 therefore forms part of the conductive path of turn L10. However, the conductive rings r1 to r6 are only attached to portions of turns and do not form part of the conductive paths of the turns.

According to the second refinement, the conductive layer on the rear face is etched so as to form, in the bypass area BA10, at least one connection pad for connecting to a turn of higher rank than turn L1 of the first group of turns L1-L6.

More specifically, the antenna coil A10 comprises here a connection pad EP2 for connecting to turn L2, a connection pad EP3 for connecting to turn L3, a connection pad EP3 for connecting to turn L3, a connection pad EP4 for connecting to turn L4, a connection pad EP5 for connecting to turn L5, and a connection pad EP6 for connecting to turn L6. Connection pads EP2 to EP6 are substantially circular and have, for example, a diameter of about 300 micrometers for a turn width of about 80 micrometers and an interturn distance of about 80 micrometers. Connection pads EP2 to EP6 are formed in the bypass area BA10 by maintaining the interturn distance dl between connection pads EP2 to EP6 and the adjacent turns so that the portions of turns L1-L10 in the bypass area have circular-arc-shaped “bulges” of increasing diameter toward the outside of the bypass area.

Optionally but preferably, the conductive layer is also etched so as to form at least one connection pad for connecting to a turn of lower rank than turn L10 of the second group of turns L7-L10. The antenna coil A10 comprises here two connection pads IP9a, IP9b for connecting to turn L9, a connection pad IP8 for connecting to turn L8 and a connection pad IP7 for connecting to turn L7. Pad IP9a is attached to the portion of turn L9 of group CA1 and pad IP9b is attached to the portion of turn L9 of group CA6. Pads IP7, IP8 are attached to the portions of turns L7, L9 of group CA1.

The second refinement can therefore provide additional connection pads to the turns of the first group, or both additional connection pads to the turns of the first group and to the turns of the second group, as shown here.

FIG. 11C shows a contactless module M10 produced on the basis of insert B10. A microcircuit MC has been attached to insert B10. The first connection terminals of the microcircuit have been connected by wires W1, W2 to the external EP1 and internal IP10 connection pads of the antenna coil A10. Second connection terminals of the microcircuit have been connected to contact pads C1, C3 to C6 on the front face (FIG. 12) by wires CW that pass through holes h1, h3 to h6. The microcircuit MC rests over part of the length and the entire width thereof on the support structure SS10 and over another part of the length and the entire width thereof on portions of turns L7 to L10 in the bypass area. The central area CA of antenna coil A10, which is bounded in this case by the contour of turn L6, has been coated with a resin layer RL to mechanically protect the wires W1, W2, CW.

FIG. 11D shows another contactless module M10′ produced on the basis of insert B10. A microcircuit MC has been attached to insert B10. The first connection terminals of the microcircuit have been connected by wires W1, W2 to the connection pad EP2 of turn L2, and to the connection pad IP9b of turn L9. Thus, turn L1 and turn L10 do not form part of the antenna coil A10 as seen from the connection terminals of the microcircuit.

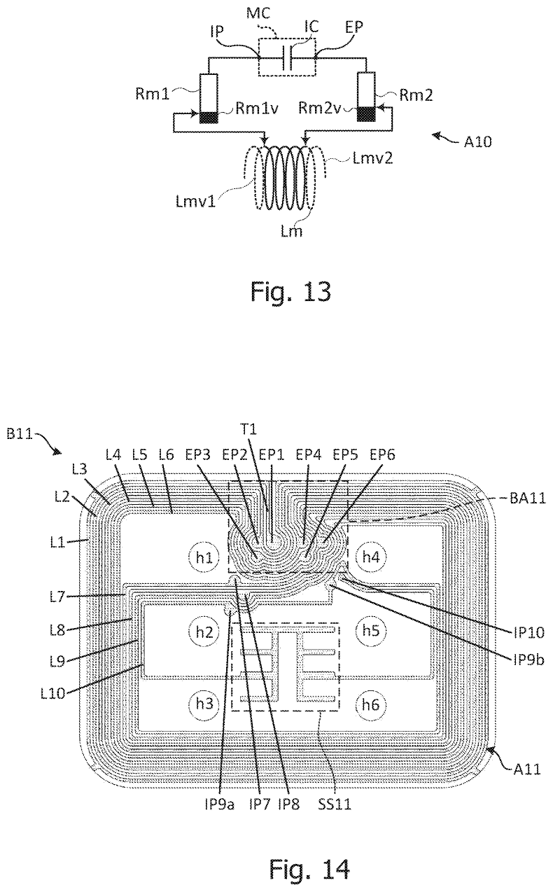

As shown in FIG. 13, the choice of the connection terminal for connecting to a turn of the first group L1-6 allows a part Lmv1 of the inductance L of the antenna coil seen by the microcircuit to be varied. The choice of the connection terminal for connecting to a turn of the second group L7-L10 allows a part Lmv2 of the inductance L of the antenna coil seen by the microcircuit to be varied. These variable parts of the inductance of the antenna coil correspond to variable parts Rm1, Rm2 of the series resistance of the antenna coil as seen by the microcircuit.

FIG. 14 shows a variant B11 of insert B10 which comprises an antenna coil A11 of the same general structure as antenna coil A10, with a support structure SS11 that is identical to support structure SS10 and a bypass area BA11 that is identical to bypass area BA10. Insert B11 differs from insert B10 in that the peripheries of holes h1 to h6 are without conductive rings. Additionally, in some embodiments, the first row of holes h1 to h3 and/or the second row of holes h4 to h6 can comprise just two holes instead of three. Specifically, depending on the application, some holes might not be used to connect the microcircuit to contact pads on the front face, as can be seen, for example, in FIG. 11D, where hole h2 is not used.

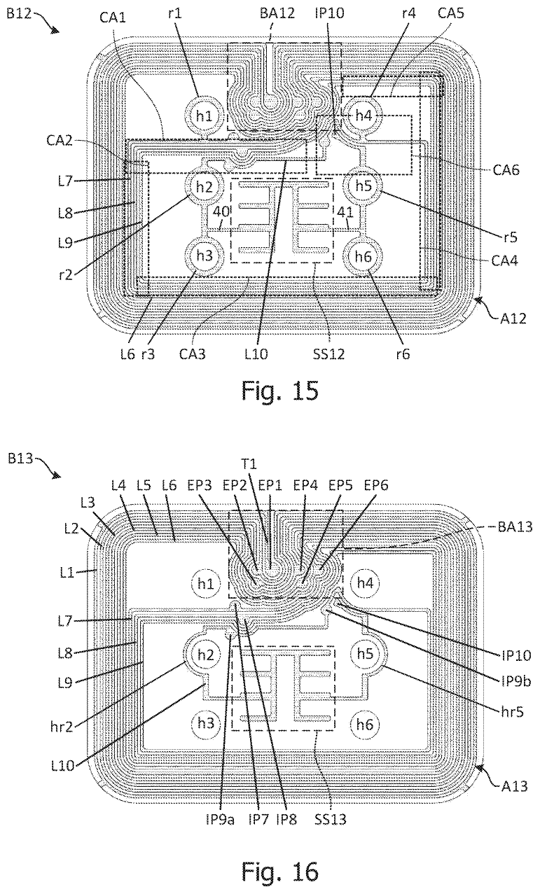

Various other variants of insert B10 can be used to produce a contactless micromodule. FIG. 15 shows a variant B12 of insert B10, comprising an antenna coil A12 which resembles antenna coil A10, with a support structure SS12 identical to support structure SS10 and a bypass area BA12 identical to bypass area BA10. Insert B12 differs from insert B10 in that some of the conductive rings, in this case conductive rings r2 and r5, form part of the conductive path of the turn L10. Thus, the portion of turn L10 of group CA2 is connected to ring r2, which is connected to the support structure SS12 via portion 40. Portion 41 of turn L10 is connected to conductive ring r5, which in turn is connected to the portion of turn L10 of group CA6, ending in connection pad IP10.

FIG. 16 shows a variant B13 of insert B12, in which the conductive rings r1, r3, r4, r6 are omitted. Conductive ring r2 is replaced by a semicircular section of track hr2 and conductive ring r5 is replaced by a semicircular section of track hr5, both semicircular sections of track forming part of the conductive path of turn L10.

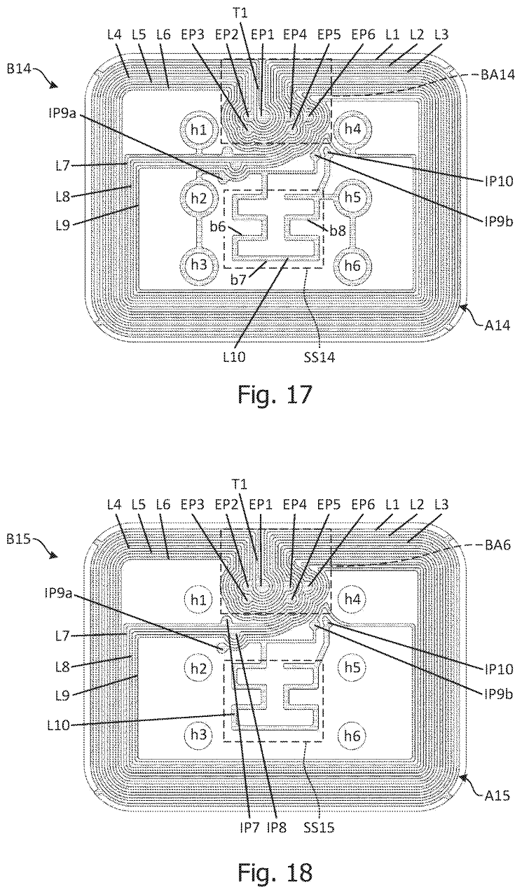

FIG. 17 shows a variant B14 of insert B12 in which turn L10 forms a support structure SS14 comprising two crenellation-shaped sections of conductive tracks b6, b8 and a straight section b7 connecting the two sections b6 and b8. Section b6 is connected to pad IP9a of turn L9 and section b8 is connected to pad IP10 of turn L10. The conductive rings extending around holes h1 to h6 are connected to the turns of the antenna coil but do not form part of the conductive paths formed by these turns. In a variant B15 of insert B14 shown in FIG. 18, these conductive rings are omitted. As previously, contactless modules can be formed on the basis of these variants B13, B14 and B15 of insert B12.

Although the first and second refinements of an antenna coil structure described hereinabove are of particular interest in the context of producing a contactless module with two operating modes, such that the presence of holes h1 to h6 has been taken into account in the preceding examples for designing the antenna coil structure, it will be clear to a person skilled in the art that certain features of these refinements are not related to the provision of contact pads on the front face of the module.

The implementation of a method for producing an antenna coil according to the first refinement can comprise a step of designing the antenna coil which comprises a prior step of determining at least one target value L for the inductance Lm of the antenna coil and a target value R for the resistance Rm of the antenna coil as should be seen from the first connection terminals of the microcircuit. This step is followed by a step of computer-aided design of the first groups of turns and of the second groups of turns, in such a way that the inductance Lm and resistance Rm of the antenna coil as seen by the microcircuit are close to the target L and R values.

The implementation of a method for producing an antenna coil according to the second refinement can comprise a step of designing the antenna coil which comprises a prior step of determining a plurality of target values L1, L2, L3 . . . for the inductance Lm of the antenna coil and target values R1, R2, R2 . . . for the resistance Rm of the antenna coil as should be seen by the microcircuit. This step is followed by a step of computer-aided design of the first group of turns and of the second group of turns, which comprises the provision of multiple connection pads for connecting to turns of different ranks of the first group of turns and/or of the second group of turns, such that the antenna coil has multiple pairs of connection pads. Each pair of connection pads comprises a connection pad for connecting to a turn of the first group of turns and a connection pad for connecting to a turn of the second group of turns. The design of the first group and of the second group of turns and the choice of the location of the connection terminals are made in such a way that the inductance Lm and the resistance Rm of the antenna coil as seen from each pair of connection pads of the antenna coil are close to one of the values of the plurality of target values L1, L2, L3 . . . for the inductance Lm and target values R1, R2, R3 . . . for the resistance Rm of the antenna coil.

To implement these design steps, it may be advisable to provide a turn width and an interturn distance that are equal to the lower limits offered by the method for etching the conductive layer, this turn width generally being greater than the skin thickness of the conductive material used, and then to seek the highest inductance between the connection terminals of the external turn and of the internal turn, in order to obtain the widest range of inductances possible by virtue of the intermediate connection pads.

Furthermore, it will be clear to a person skilled in the art that the second refinement can be implemented without the first refinement, for example in an antenna structure comprising only one group of turns, by providing a connection terminal for each turn in the bypass area. For example, this could be antenna coil A14 of FIG. 17 without turns L7, L8 and L9, with turn L10 then becoming turn L7.

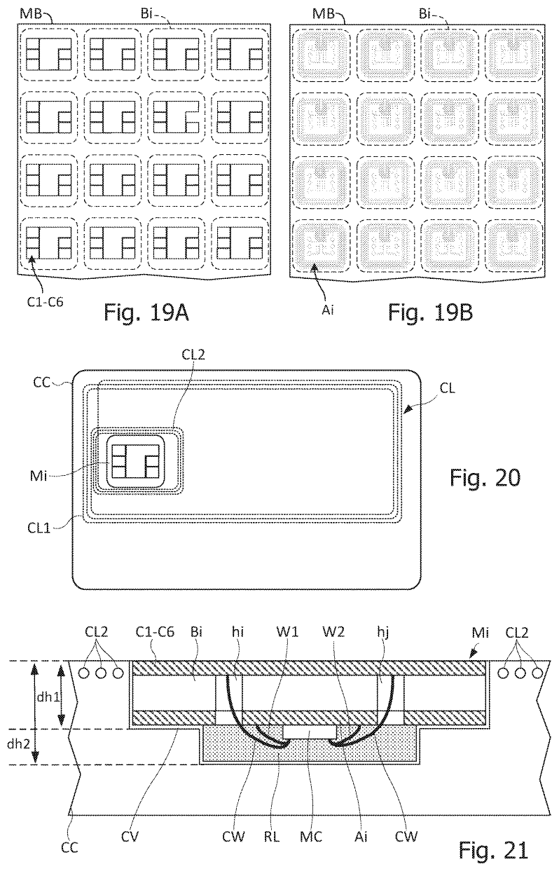

According to one embodiment shown in FIG. 19 (FIGS. 19A and 19B), inserts Bi are batch-produced by etching a board MB covered on each face with an electrically conductive layer. The board can be a double-sided printed circuit board. FIGS. 19A and 19B show the front and rear faces of a portion of the board MB after etching both sides. In FIG. 19A, the board MB comprises multiple sets of contact pads C1-C6. The C1-C6 contact pad assemblies are arranged in rows and columns on the MB plate. In FIG. 19B, a number of coils Ai are formed on the rear face of the MB plate, each coil facing a set of contact pads C1-C6.

In a subsequent step (not shown), the plate MB can be drilled from the rear into the central area of each coil Ai to form holes in the plate reaching contact pads C1-C6. A microcircuit can be placed in the center of each coil Ai, then connected by wires to contact pads C1-C6 and coil Ai. The RL resin layer described above is then deposited to protect each microcircuit with its connection wires without covering all or part of the turns of the Ai antenna coils. For this purpose, several techniques well known to the skilled worker can be used:
by injection and thermal curing of an epoxy resin using molds,
using a dam & fill technique involving two UV-curable materials,
by “potting”, which involves depositing a drop of material that is activated by heat or UV light. This technique is the least expensive, but is not very precise in terms of the thickness and surface area occupied by the resin layer.

In one variant, the MB plate is drilled to form holes h1-h6 before being covered with the front and rear conductive layers. In one example, an epoxy-glass base substrate comprising a copper layer on its rear face is given a copper layer on its front side with an adhesive layer in between. The two copper-coated faces are then etched and drilled to form the two rows of holes h1-h6.

FIG. 20 shows a CC card comprising a contactless module Mi according to one or both of the above-described refinements. FIG. 21 is a cross-sectional view of the CC card. The CC card comprises a cavity CV accommodating the Mi module, an antenna coil CL which is included in the body of the card and comprises one or more large CL1 turns and one or more small CL2 turns. The small CL2 coils surround the Mi module and provide inductive coupling between the Mi module's Ai antenna coil and the CL antenna coil. Contact pads C1-C6 and antenna coil Ai of module Mi are schematically represented by a hatched layer in FIG. 21. FIG. 21 shows the wires CW of the module Mi passing through holes hi, hj of the set of holes h1-h6, and the wires W1, W2 connecting the first connection terminals of the microcircuit MC to connection pads of antenna coil Ai, as well as the resin layer RL encapsulating the microcircuit and the wires W1, W2, CW.

The cavity CV has a first depth dh1 at the periphery thereof which allows it to accommodate the periphery of the contactless module Mi. The depth dh1 is preferably substantially less than the sum of the thickness of the insert Bi from which the contactless module Mi is made, the thickness of an adhesive used to fix the module Mi in the cavity, the thickness of the conductive layer forming antenna coil Ai and the thickness of the conductive layer forming contact pads C1-C6 on the front face, and is calculated so that contact pads C1-C6 protrude substantially beyond the surface of the card (typically from 10 to 50 micrometers).

The cavity CV also has a central region whose depth dh2 must be substantially greater than the sum of the first depth dh1 and the thickness of the resin layer RL, so that an empty space, for example 20 micrometers, remains to absorb the variations in distance between the bottom of the cavity and the rear face of the module when the card is subjected to bending.

As mentioned above, the surface area of the central region of the cavity with depth dh2 should preferably be as small as possible compared with the total surface area of the cavity, so as not to weaken the card. For this reason, it is desirable to keep the surface area of the module covered by the RL resin layer to a minimum. This minimum area corresponds substantially to the central region of the coil in which the wires W1, W2, CW extend, to which a safety edge can be added.

1. A method for producing a contactless module, the method comprising the steps of:
depositing a first electrically conductive layer on a first face of an insert;
forming an antenna coil by etching the first layer, the antenna coil comprising turns of increasing rank from the outside to the inside of the antenna coil, including an external turn of rank 1 and an internal turn of rank N, the internal turn being connected to an internal connection pad and the external turn being connected to an external connection pad;
attaching a microcircuit to the first face of the insert, in a central area of the antenna coil bounded by a turn of the antenna coil;
connecting first connection terminals of the microcircuit to connection pads of the antenna coil, via wires;
in which method the external and internal connection pads of the antenna coil are formed in the central area of the antenna coil, the antenna coil comprising a bypass area in which each turn bypasses the external connection pad via the central area;
wherein the conductive layer is etched in such a way that the antenna coil comprises, in the bypass area, at least one connection pad for connecting to a turn of rank greater than 1 to which at least one of the first connection terminals of the microcircuit is connected or can be connected.

2. The method as claimed in claim 1, wherein the conductive layer is etched in such a way that:
the antenna coil comprises a first group of turns of ranks 1 to E, the turns of the first group having substantially the same interturn distance, the turn of rank E being the internal turn of the first group of turns, E being at least equal to 4;
the central area is bounded by the contour of the internal turn of rank E of the first group of turns; and
the antenna coil comprises a second group of at least two turns of ranks E+1 to N, which extends into the central area, each turn of the second group of turns comprising turn portions which are situated at variable distances from the turn of preceding rank, said distances being between said interturn distance and multiple times the interturn distance.

3. The method as claimed in claim 2, wherein the conductive layer is etched in such a way that the antenna coil comprises at least one connection pad for connecting to a turn of rank lower than N of the second group of turns.

4. The method as claimed in claim 3, wherein the microcircuit is fully or partly supported by at least the internal turn of the antenna coil and can also be supported by at least one turn portion of the first group of turns extending into the bypass area.

5. The method as claimed in claim 2, the method further comprising the steps of:
depositing a second electrically conductive layer on a second face of the insert;
forming contact pads in the second layer;
forming two rows of two or three holes each in the insert until the contact pads of the second layer are reached, the rows of holes being substantially perpendicular to a longitudinal axis of the module; and
connecting second connection terminals of the microcircuit to the contact pads of the second layer via wires that pass through the holes,
and wherein all or some of the turns of the second group of turns follow a path that passes between at least two holes of at least one row of holes.

6. The method as claimed in claim 1, wherein the conductive layer is etched so as to comprise a support structure for supporting all or part of the microcircuit, the support structure being electrically connected to a turn of the antenna coil.

7. The method as claimed in claim 6, wherein at least a portion of the support structure forms a conductive path which forms part of the internal turn of the antenna coil.

8. The method as claimed in claim 1, the method further comprising a step of depositing an electrically insulating protective layer on the microcircuit and the connection wires.

9. The method for producing a contactless module as claimed in claim 1, the method further comprising a step of designing the antenna coil which comprises:
a step of determining a plurality of target values for the inductance and target values for the resistance of the antenna coil as should be seen from the first connection terminals of the microcircuit;
a step of designing the turns of the antenna coil, the step comprising the provision of multiple connection pads for connecting to turns of different ranks,
such that the antenna coil has multiple pairs of connection pads, each pair of connection pads comprising a connection pad for connecting to a turn of the first group of turns and a connection pad for connecting to a turn of the second group of turns,
in which method the choice of the location of the connection terminals is made in such a way that the inductance and the resistance of the antenna coil as seen from each pair of connection pads of the antenna coil are close to one of the values of the plurality of target values for the inductance and target values for the resistance of the antenna coil.

10. A method for producing a microcircuit card, the method comprising the steps of:
carrying out the method as claimed in claim 1 to obtain a contactless module;
forming an antenna coil in a card; and
implanting the module into the card, the antenna coil of the card having at least one turn close to the antenna coil of the microcircuit in order to establish an inductive coupling between the two antenna coils.

11. A contactless module comprising:
an insert comprising, on a first face, an antenna coil comprising turns of increasing rank from the outside to the inside of the antenna coil, including an external turn of rank 1 and an internal turn of rank N, the internal turn being connected to an internal connection pad and the external turn being connected to an external connection pad;
a microcircuit attached to the first face of the insert, in a central area of the antenna coil bounded by a turn of the antenna coil, and comprising first connection terminals connected to connection pads of the antenna coil via wires,
wherein the external and internal connection pads of the antenna coil are formed in the central area of the antenna coil, the antenna coil comprising a bypass area in which each turn bypasses the external connection pad via the central area,
wherein the antenna coil comprises, in the bypass area, at least one connection pad for connecting to a turn of rank greater than 1 to which at least one of the first connection terminals of the microcircuit is connected or can be connected.

12. The module as claimed in claim 11, wherein:
the antenna coil comprises a first group of turns of ranks 1 to E, the turns of the first group having substantially the same interturn distance, the turn of rank E being the internal turn of the first group of turns, E being at least equal to 4;
the central area is bounded by the contour of the internal turn of rank E of the first group of turns; and
the antenna coil comprises a second group of at least two turns of ranks E+1 to N, which extends into the central area, each turn of the second group of turns comprising turn portions which are situated at variable distances from the turn of preceding rank, said distances being between said interturn distance and multiple times the interturn distance.

13. The module as claimed in claim 12, wherein the antenna coil comprises at least one connection pad for connecting to a turn of rank lower than N of the second group of turns.

14. The module as claimed in claim 13, wherein the microcircuit is fully or partly supported by at least the internal turn of the antenna coil and can also be supported by at least one turn portion of the first group of turns extending into the bypass area.

15. The module as claimed in claim 11, the module comprising:
contact pads on a second face of the insert;
two rows of two or three holes each which pass through the insert until the contact pads on the second face of the insert are reached, the rows of holes being substantially perpendicular to a longitudinal axis of the module;
wires that pass through holes connecting second connection terminals of the microcircuit to the contact pads of the second face of the insert;
and wherein all or some of the turns of the second group of turns follow a path that passes between at least two holes of at least one row of holes.

16. The module as claimed in claim 11, the module comprising a support structure for supporting all or part of the microcircuit, the support structure being electrically connected to a turn of the antenna coil.

17. The module as claimed in claim 16, wherein at least a portion of the support structure forms a conductive path which forms part of the internal turn of the antenna coil.

18. The module as claimed in claim 11, the module comprising an electrically insulating protective layer on the microcircuit and the connection wires.

19. A microcircuit card comprising an antenna coil and a module as claimed in claim 11, the antenna coil of the card having at least one turn close to the antenna coil of the module in order to establish an inductive coupling between the two antenna coils.
